(19) United States
(12) Patent Application Publication
(10) Pub. No.: US 2010/0302555 A1
(43) Pub. Date: Dec. 2, 2010

(54) Metrology system and method for monitoring and correcting system generated errors

(75) Inventors: Hans-Artur Boesser, Breidenbach (DE); Slawomir Czerkas, Weilburg (DE)

Correspondence Address: Davidson, Davidson & Kappel, LLC, 485 7th Avenue, 14th Floor, New York, NY, 10018, US

(73) Assignee: KLA-Tencor MIE GmbH, Weilburg (DE)

(21) Appl. No.: 12/799,362

(22) Filed: Apr. 23, 2010

(30) Foreign Application Priority Data
Jun. 2, 2009 (DE) DE 102009025895.7

(51) Int. Cl. G01B 11/02

(52) U.S. Cl. 356/620; 356/244

(57) ABSTRACT

A metrology system (1) and a method for determining low order errors are disclosed. At least one measurement objective (9) for the determination of the position of structures (3) on a substrate (2) is provided. The substrate (2) to be measured rests in a support on three points of support (52). The support exhibits an opening (53) for measuring the substrate (2). At least two marks (54) are provided on the support for the mask (2) in such a way that the marks (54) are capturable with the measurement objective (9) by moving the measurement table (20). Furthermore the substrate (2) in the support does not screen the marks (54) on the support.

### CROSS REFERENCE TO RELATED APPLICATIONS

This patent application claims the benefit of German Patent Application No. 10 2009 025 895.7, filed on Jun. 2, 2009 and is hereby incorporated by reference herein

### FIELD OF THE INVENTION

The present invention relates to a metrology system. The metrology system exhibits at least one measurement objective for determining positions of structures on a substrate. Furthermore a measurement table, movable at least in X-coordinate direction and at least in Y-coordinate direction, for holding the substrate is provided. The measurement table exhibits a support, into which the substrate to be measured can be placed. The support essentially has the shape of the substrate, so that the structures to be measured on the surface of the substrate can be illuminated by an illumination system.

A person skilled in the art can design the support for the substrate in an arbitrary manner. The only requirement is that the substrate, like for example mask or wafer, fits into the support completely. The support and its design for the substrate essentially are determined by the metrological requirements of the measurement, like for example precision or repeatability.

The invention furthermore relates to a method for monitoring and/or correcting errors in a metrology system. The errors are errors of first order or errors of second order. The errors for example are errors in orthogonality, which arise, inter alia statistically, in a metrology system.

### BACKGROUND OF THE INVENTION

A metrology system is sufficiently known in the state of the art. For example, reference is made to the presentation manuscript “Pattern Placement Metrology for Mask making” by Dr. Carola Bläsing. The presentation was given at the conference Semicon, Education Program, on 31 Mar. 1998 in Geneva, wherein a metrology system was described in detail. The setup of a metrology system, as it is known for example from the state of the art, is explained more closely in the subsequent description of FIG. 1.

The German patent DE 197 34 695 D1 discloses a method for the correction of a system. Therein the coordinates of structures on an uncalibrated reference object are measured in plural angular positions on the measurement table of the metrology system. The measured coordinates are automatically rotated back into the starting position by rotation functions. Therefrom a correction function is determined in such a way that the coordinates rotated back are in optimal agreement with the coordinates of the starting position. Therein each reference object is only rotated around one axis. The symmetric linear combinations of the fitting functions used in the approximation of the correction function are determined and are not considered in the approximation. The generated correction functions are systematically complete and do not contain over-determined or erroneous terms.

The German patent application DE 10 2007 030 390 A1 discloses a metrology system, to which there corresponds a device for automatically aligning a substrate. The metrology system there further comprises a control and computation unit, so that a self-calibration based on at least two different and automatically set alignments of the substrate is performable. This automatic correction can be performed automatically in certain periodic time intervals.

Normally the operator of a metrology system daily checks the state of the metrology system by measurements, setting one or plural angular positions of the substrate and measuring the positions of the structures on the substrate in each of the set angular positions. If the metrology system has drifted, it is corrected based on these measurements. This method, however, does not provide a possibility to monitor and correct errors which arise irregularly, for example during loading a metrology system.

### SUMMARY OF THE INVENTION

It is an object of the present invention to provide a metrology system which is able to monitor and/or correct errors arising irregularly, which affect the precision and/or repeatability of measurements obtained with a metrology system.

The present invention provides a metrology system comprising at least one measurement objective for determining the position of structures on a substrate; a measurement table movable in at least one X-coordinate direction and in at least one Y-coordinate direction; a support for the substrate with the structures to be measured is provided on the measurement table, wherein the support has the shape of the substrate; at least two marks are provided on the support for the substrate in such a way that the marks are detectable with the measurement objective by moving the measurement table and that the substrate on the support does not screen the marks on the support.

It is a further object of the invention to provide a method by which monitoring and/or automatic self-correction of irregular errors with respect to the measurement precision and/or repeatability of the metrology system is performable.

The present invention also provides a method comprising the following steps:

providing at least two marks at a distance from each other in the region of the support in such a way that these marks are not screened by the substrate to be measured;

moving the measurement table with the substrate or without the substrate automatically and/or at regular time intervals and/or started by the operator, in such a way that a position of the marks with respect to the coordinate system of the metrology system is measured;

obtaining from the position of at least two marks information on the state of the system and wherein the information is adequately displayed and/or archived; and/or

obtaining a correction, wherein the obtained correction is applied to the measured values with respect to the positions of the structures on the substrate.

The state of the metrology system in general can change erratically at certain events, like for instance loading with a substrate (mask or wafer). At present such changes can neither be eliminated nor monitored by operators of the metrology system. These changes significantly deteriorate the long-term and/or precision performance and/or the repeatability. In order to be able to detect such errors and to take corresponding measures regarding their correction, it is necessary for the support for the mask in the metrology system to exhibit at least two marks. Therein the at least two marks are provided on the support for the substrate in such a way that the marks are capturable from the measurement objective of the metrology system by moving the measurement table. Furthermore the masks are arranged in such a way on the support that a substrate in the support does not screen the marks on the support.

It may be sufficient for the determination of selected errors (for example orthogonality errors) that two marks are provided at a distance from each other on the support. It is, however, self-evident that more than two marks may be provided for the determination of these errors. Based on these marks usually only selected error terms of the already available correction are corrected again. If polynomial correction functions are used, usually all or selected error terms of first and/or second order are corrected again. If a different function basis is used (for example trigonometric functions), analogously error terms, which are of low frequency, are corrected again.

The substrate can be a mask for semiconductor manufacturing or a wafer. If the substrate is a mask, the support preferentially is an opening, so that the mask can be illuminated with a top-light system and/or a transmitted-light system. The opening is the support for the mask. The support can be formed in the measurement table itself. The opening in the measurement table exhibits two opposite edges, on which, respectively, the mark is provided. The position of each mark with respect to the coordinate system of the metrology system is determinable. The opening preferentially exhibits three points of support, on which the mask rests in the metrology system.

Furthermore a mirror body can be provided on the measurement table of the metrology system. The marks to be measured here also are provided around an opening for the mask provided in the mirror body. The measurement table of the metrology system therein is movable by such a distance that the marks can be captured and measured with the measurement objective of the metrology system.

Furthermore the marks can also be provided on a mask frame, which is placeable into the mirror body together with the mask. Here, also, the marks are provided around the opening of the mask frame, into which the mask to be measured can be placed.

In the case that the substrate to be measured is a wafer the measurement table preferentially carries a wafer chuck for holding the wafer. On the edge of the wafer chuck at opposite positions, respectively, a mark is provided. The position of each mark with respect to the coordinate system of the metrology system is determinable.

The measurement table itself can be a mirror body. Alternatively, the measurement table can carry the mirror body, which in turn carries the wafer chuck. The marks can also be provided on the mirror body and/or the wafer chuck.

It is also possible to use a chuck for other substrates, for example for a mask.

To the metrology system there correspond a robot, a magazine for the substrates, and a device for aligning the substrates. The robot therein is designed in such a way that it passes the substrates to the device for aligning, and after aligning removes the substrates from the device for aligning. Also the robot is suitable for removing a substrate from the magazine and putting it on the support of the metrology system.

The method according to the invention for monitoring and correcting system generated errors is implemented with a metrology system. The metrology system exhibits at least one measurement objective for the determination of the position of structures on a substrate. Furthermore a measurement table movable in X-coordinate direction and in Y-coordinate direction is provided. The measurement table exhibits a support for the mask.

In the case that the substrate is a mask, the support can exhibit an opening in the shape of the mask, so that the mask can be illuminated both with a transmitted-light system and/or with a top-light system. For the determination of the errors (for example orthogonality errors) at least two marks are provided at a distance from each other in the region outside the opening, wherein these marks are not covered by the mask to be measured. After placing the mask in the measurement table and/or at regular time intervals the measurement table is moved in such a way that a position of the marks with respect to the coordinate system of the metrology system is measured and a correction is determined therefrom. Based on the measured position of the at least two marks the distance between these two marks can be determined. A correction value or a correction is derivable for example from the distance between the two measured marks. The correction obtained is applied to the measurements with respect to the positions of the structures on the mask.

The position of the marks in the region outside the opening can be measured at regular time intervals and/or automatically, like for example after each loading of the measurement table with a mask, and/or started manually. Through the correction for example first order error terms are corrected. The correction of high frequency error terms is unchanged, so that also the orthogonality errors can be both monitored as well as corrected.

The marks can be designed in such a way that particular errors manifest themselves there at a magnified or reduced extent, respectively, and therefore selected error terms and/or sources of errors can be specifically monitored.

The correction determined based on the position of at least two marks can be determined in the loaded and/or the unloaded state of the metrology system with a substrate.

As already mentioned, the substrate can also be a wafer. The support for the wafer is a wafer chuck and the marks are provided correspondingly on the edge of the wafer chuck. Here the same conditions for providing the marks apply as in the case of the substrate being a mask. It is always necessary to provide the marks in such a way that they are not screened by the wafer placed in the wafer chuck.

Furthermore the marks can be designed in such a way that in addition to the position of the masks in X-coordinate direction and in Y-coordinate direction also the position of the mark in Z-coordinate direction can be captured. For the subsequent correction with respect to the position of the marks either the X-coordinate direction, Y-coordinate direction, and Z-coordinate direction, or only a part of the measured positions in the coordinate directions can be used.

### BRIEF DESCRIPTION OF THE DRAWINGS

In what follows embodiments shall illustrate the invention and its advantages with reference to the accompanying figures.

FIG. 1 schematically shows the setup of a metrology system according to the state of the art.

FIG. 2 schematically shows the setup of a system with which the coordinates of structures on the surface of a mask can be measured, and wherein to the system there corresponds a device for aligning the masks.

FIG. 3 shows a perspective view of a mirror body as it is used in the metrology system, which exhibits marks for determining the ortho-jumps of a metrology system.

FIG. 4 shows a top view of a substrate frame, which also exhibits marks for the determination of ortho-jumps.

### DETAILED DESCRIPTION OF THE INVENTION

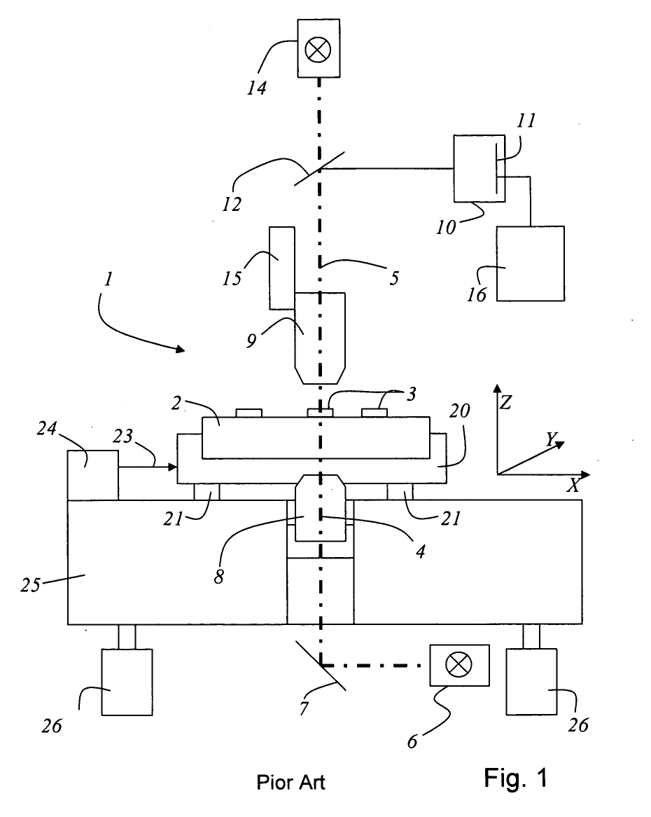

The same reference numeral is used for like elements of the invention or for elements of like function. Though the subsequent description restricts itself to a mask, this is not to be taken as a limitation of the invention. It is obvious to a person skilled in the art that a wafer chuck is used for holding a wafer in the metrology system. The design of a wafer chuck is widely known and need not be described here again. Furthermore it is self-evident that the wafer is illuminated with a top-light system only in the metrology system. Though the metrology system subsequently described in FIG. 1 shows both a top-light system and a transmitted-light system as illumination system, it is obvious that for illuminating the substrate in the case of a wafer only the top-light illumination system is used. Depending on the measurement problem and/or the wavelength used, only the top-light illumination system may be used.

A metrology system of the kind shown in FIG. 1 has been described in detail in the state of the art already, and thus also is known in detail from the state of the art. The metrology system 1 comprises a measurement table 20 movable in X-coordinate direction and in Y-coordinate direction. Therein the measurement table 20 may be designed in such a way that it directly carries a substrate or a mask 2 for semiconductor manufacturing, respectively. The mask 2 for semiconductor manufacturing exhibits structures 3 on its surface, the position of which with respect to a coordinate system of the metrology system 1 are to be measured. According to further embodiments a mirror body (not shown) can be provided on the measurement table 20, wherein the mirror body carries the mask 2 itself or a mask frame (not shown) for the mask 2. The position of the measurement table 20 is measured by at least one laser interferometer 24, which emits a light beam. The measurement table 20 rests on bearings 21 in X-coordinate direction and in Y-coordinate direction on the block 25, which is a block of granite. The measurement table 20, the mirror body, and the substrate frame exhibit an adequate opening (not shown) so that the mask 2 can be illuminated both with a top-light illumination 14 and with a transmitted-light illumination 6. In the embodiment shown in FIG. 1 the light for the transmitted-light illumination 6 is coupled into the illumination axis 4 for transmitted light by a tilted mirror. The light of the illumination system reaches the mask 2 through a condenser 8. The light of the top-light illumination system 14 reaches the mask 2 through the measurement objective 9. The light from the mask 2 is collected by the measurement objective 9 and coupled out of the optical axis 5 by a beam splitter 12. The measurement light reaches a camera 10, which is provided with a detector 11. To the detector 11 there corresponds a computation unit 16, by which digital images can be generated from the recorded data, or by which the data are evaluated with respect to the position of the recorded structures, respectively. The measurement objective 9 is connected with a displacement device in Z-coordinate direction, in order that the measurement objective 9 can be focused on the surface of the mask 2. By it the measurement objective 9 can also be focused on the marks provided outside the mask 2 in order to determine, based on these marks, the ortho-jumps or the correction following from the ortho-jumps, respectively. The block 25 is furthermore set on vibration-damped supports 26. By this vibration-damping all possible vibrations of the building and of the metrology system 1 itself are to be reduced as much as possible or eliminated.

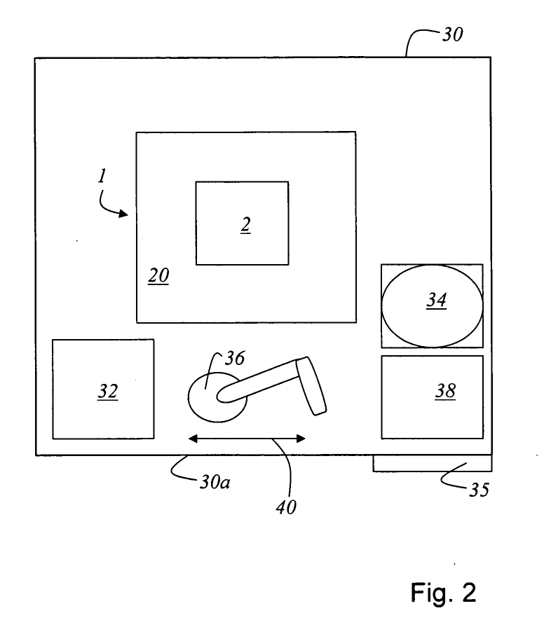

FIG. 2 shows a schematic view of the arrangement of a metrology system 1 and further apparatuses which pertain to the metrology system 1, in order to assure an efficient and repeatable measurement of the structures on the surface of the mask 2. In the embodiment shown in FIG. 2 the metrology system 1 is shown in a simplified manner. The metrology system 1 in FIG. 2 is restricted to the measurement table 20 and the mask 2 on the measurement table 20, only. The metrology system 1 is located within a climate chamber 30 together with further apparatuses. To the metrology system 1 there corresponds in the embodiment shown here a magazine 32 for storing masks 2 within the climate chamber 30. Likewise within the climate chamber 30 a device 34 for aligning the mask is provided. A hand-over port 35 can be provided in one panel 30a of the climate chamber 30, through which masks 2 can be transferred to the interior of the climate chamber 30. Furthermore a transport robot 36 is provided for the metrology system 1, the magazine 32, and the device 34 for aligning. It is also possible to provide a further transport system 38, which for example establishes the communication between the hand-over port 35 and the device 34 for aligning the masks. Though in the embodiment shown a magazine 32 is provided for storing masks or for adjusting the temperature of masks 2, it is obvious for every person skilled in the art that a magazine 32 within the climate chamber 30 is also an option. The robot 36 can be moved along the direction indicated by the double arrow 40 within the climate chamber 30. Thus it is possible for the robot 36 to place the masks 2 for, example from the magazine 32 onto the metrology system 1. It is also possible to provide masks 2 to the various apparatuses within the climate chamber 30 with the robot 36, and to transport the masks 2 between the individual apparatuses.

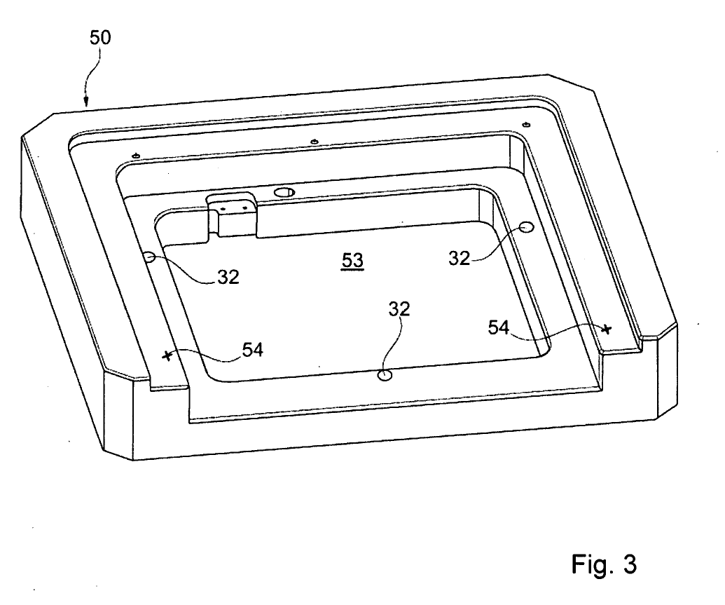

FIG. 3 shows a perspective view of a mirror body 50, which is suited for holding a mask 2 or a mask frame (not shown) for the mask 2, respectively. The mirror body 50 exhibits an opening 53, so that the mask placed into the mirror body 50 can be illuminated with top-light and/or transmitted light. The mask 2 or the substrate frame, respectively, rest on three points of support 32 in the mirror body 50. In the embodiment shown in FIG. 5 the support for the mask 2 is the mirror body 50. Furthermore two marks 54 are provided on the mirror body 50, which also can be measured with the measurement objective 9 of the metrology system 1 with respect to the position in X-coordinate direction, in Y-coordinate direction, and in Z-coordinate direction. In the embodiment shown in FIG. 5 the marks are provided on the edge of the opening 54 in such a way that a substrate frame placed in the mirror body 50 or a mask 2 placed in the mirror body 50 do not screen the marks 54. Though in the embodiment shown in FIG. 3 only two marks at a distance from each other are shown, this is not to be taken as a limitation of the invention. It is possible to provide more than two marks 54, which can be used for determining the correction in an analogous manner.

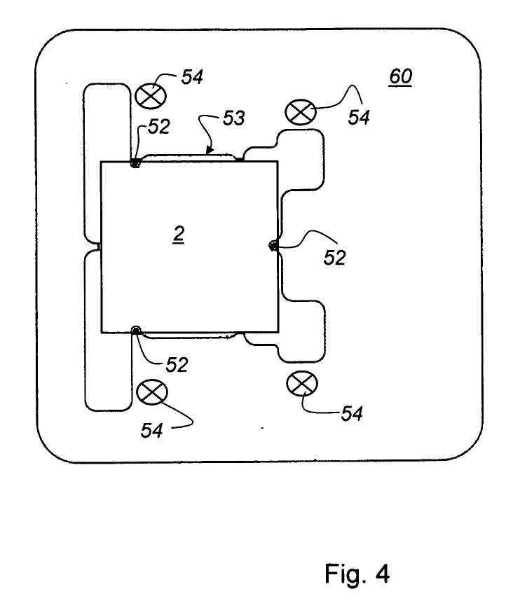

FIG. 4 shows a further embodiment by which it is possible to determine the correction in a metrology system 1. A substrate frame 60 for the mask 2 exhibits an opening 53. The mask 2 can be placed in the opening 53 and there rests on three points of support 52. Outside the opening 53 at least two marks 54, based on which it is possible to monitor and if necessary correct the state of the system, are provided on the substrate frame 60. The measurement table 20 of the metrology system 1 therein is movable in such a way that the marks 54 can be imaged onto the camera with the measurement objective 9. The measurement of the marks 54 on the mirror body 50, on the substrate frame 60, or on the measurement table 20 can be done automatically. It is also possible to perform this measurement at each loading of the measurement table 20 with a new mask 2. As a small number of marks 54 is to be measured, this measurement can be done very quickly and thus does not significantly affect the throughput of the masks 2 to be measured with the metrology system 1. The measurement of the marks 54 can in addition to the measured lateral position in X-coordinate direction and in Y-coordinate direction also record the height of the marks 54 in Z-coordinate direction. Thus it is possible to measure with one measurement and eventually to use for the correction a complete 3-D-position in space or only a part of the information.

The method for monitoring and/or correcting system generated errors is used with a metrology system, like for example described in FIG. 1. The metrology system 1 exhibits at least one measurement objective 9 for determining the position of structures 3 on a substrate 2. In order to move the plurality of structures on the surface of the substrate into the optical axis of the measurement objective, a measurement table 20, movable at least in X-coordinate direction and at least in Y-coordinate direction, is provided. The measurement table 20 exhibits a support for the substrate 2 so that the substrate can be illuminated with an illumination system 6.

In the region of the support at least two marks 54 are provided at a distance from each other in such a way that these marks 54 are not covered by the substrate 2 to be measured.

With substrate 2 and/or without substrate 2 the measurement table 20 is, automatically, and/or at regular time intervals, and/or started by the operator, moved in such a way that a position of the marks 54 with respect to the coordinate system of the metrology system 1 can be measured. Based on the position of at least two marks 54 information on the status of the system is obtained and is adequately displayed and/or archived.

Also, a correction can be obtained therefrom, wherein the obtained correction is applied to the measured values with respect to the positions of the structures 3 on the substrate 2.

For the correction it is sufficient to measure a distance between at least two marks 54 automatically and/or at regular time intervals. The substrate 2 is a mask for semiconductor manufacturing or a wafer.

The marks 54 are of such design that in addition to the position of the marks in X-coordinate direction and in Y-coordinate direction also the position of the mark in Z-coordinate direction can be recorded, wherein for the correction either the position of the marks 54 in X-coordinate direction, Y-coordinate direction, and Z-coordinate direction or only a part of these measured positions in the coordinate directions is used.

The correction determined based on the position of at least two marks 54 can be determined in the loaded state and/or in the unloaded state of the metrology system 1 with a substrate 2.

The invention has been described with reference to specific embodiments. It is, however, conceivable that modifications and alterations can be made without leaving the scope of the subsequent claims.

What is claimed is:

1. A metrology system comprising:
at least one measurement objective for determining a position of structures on a substrate;
a measurement table movable in at least one X-coordinate direction and in at least one Y-coordinate direction;
a support for the substrate with the structures to be measured is provided on the measurement table, wherein the support has the shape of the substrate;
at least two marks being provided on the support for the substrate in such a way that the marks are detectable with the measurement objective by moving the measurement table, the substrate on the support not screening the marks on the support.

2. The metrology system as recited in claim 1 wherein the at least two marks are provided at a distance from each other on the support.

3. The metrology system as recited in claim 1 wherein the support is defined by an opening having three points of support, the substrate resting in the metrology system on the three points of support.

4. The metrology system as recited in claim 3 wherein the opening is defined by the measurement table and one of the at least two marks is provided at least on each of two opposite edges of the opening, wherein the position of each mark with respect to a coordinate system of the metrology system is determinable.

5. The metrology system of claim 4 wherein the measurement table carries a mirror body, wherein the at least two marks are provided on the mirror body, and wherein the mirror body also defines the opening with the three points of support, on which the substrate rests.

6. The metrology system as recited in claim 5 wherein the mirror body carries a substrate frame, and wherein further of the at least two marks also are provided on the substrate frame, and wherein the substrate frame defines the opening, in which the substrate rests.

7. The metrology system as recited in claim 1 wherein the substrate is a wafer exhibiting the structures to be measured.

8. The metrology system as recited in claim 7 wherein the measurement table itself exhibits the support and that the support is a wafer chuck, wherein a mark of the at least two marks is provided on the edge of the wafer chuck at opposite positions, respectively, wherein the position of each mark with respect to a coordinate system of the metrology system is determinable.

9. The metrology system as recited in claim 8 wherein the measurement table carries a mirror body, which carries the wafer chuck, wherein the marks of the at least two marks are provided on the mirror body and on the wafer chuck.

10. The metrology system as recited in claim 1 wherein the measurement table is movable in the X-coordinate direction and/or in Y-coordinate direction and/or in Z-coordinate direction.

11. A method for monitoring and/or correcting system generated errors, wherein a metrology system comprises at least one measurement objective for determining a position of structures on a substrate, a measurement table movable at least in X-coordinate direction and at least in Y-coordinate direction, wherein the measurement table exhibits a support for the substrate with the structures to be measured, so that the substrate is illuminatable with an illumination system, the method comprising the following steps:
providing at least two marks at a distance from each other in a region of the support in such a way that these marks are not screened by the substrate to be measured;
moving the measurement table with the substrate or without the substrate automatically and/or at regular time intervals and/or started by the operator, in such a way that a position of the marks with respect to the coordinate system of the metrology system is measured; and
obtaining from the position of the at least two marks information on a state of the system and wherein the information is adequately displayed and/or archived, and/or obtaining a correction, wherein the obtained correction is applied to the measured values with respect to the positions of the structures on the substrate.

12. The method as recited in claim 11 wherein for the correction a distance between the at least two marks is measured automatically and/or at regular time intervals.

13. The method as recited in claim 11 wherein selected or all first order error terms are corrected, whereas the correction of higher frequency error terms is unchanged.

14. The method as recited in claim 11 wherein the at least two marks are designed in such a way that particular errors manifest themselves there at a magnified or reduced extent, respectively, and thus selected error terms or sources of error are specifically monitorable.

15. The method as recited in claim 11 wherein the marks are designed in such a way that in addition to the position of the marks in X-coordinate direction and in Y-coordinate direction also the position of the mark in Z-coordinate direction can be determined, wherein for the correction either the position of the marks in the X-coordinate direction, the Y-coordinate direction, and the Z-coordinate direction, or only a part of these measured positions in the coordinate directions is used.

16. The method as recited in claim 11 wherein the correction determined based on the position of the at least two marks is determined in the loaded and/or unloaded state of the metrology system with a substrate.
